(19) United States
(12) Patent Application Publication
(10) Pub. No.: US 2015/0304833 A1
(43) Pub. Date: Oct. 22, 2015

(54) BLUETOOTH ATTRIBUTE REPEATER AND AGGREGATOR

(71) Applicant: Laird Technologies, Inc., Earth City, MO (US)

(72) Inventors: Mahendra Tailor, Wembley (GB); Benjamin John Whitten, Wooburn Green (GB)

(73) Assignee: Laird Technologies, Inc., Earth City, MO (US)

(21) Appl. No.: 14/283,361

(22) Filed: May 21, 2014

Related U.S. Application Data
(60) Provisional application No. 61/981,367, filed on Apr. 18, 2014.

(51) Int. Cl. H04W 8/00; H04W 48/16; H04W 4/00

(52) U.S. Cl. CPC H04W 8/005; H04W 4/008; H04W 48/16

(57) ABSTRACT

According to various aspects, exemplary embodiments are disclosed of a Bluetooth attribute repeating and aggregating apparatus. In an exemplary embodiment, a Bluetooth attribute repeating and aggregating apparatus generally includes first and second communication modules. The first communication module is configured as a Bluetooth master for receiving attributes from one or more target Bluetooth slave devices. The second communication module is configured as a Bluetooth slave for processing the received attributes and transmitting corresponding attribute information to a control Bluetooth master device. The first communication module is coupled to the second communication module via a hardware interface. The first communication module is configured to transmit the received attributes to the second communication module via the hardware interface.

### CROSS-REFERENCE TO RELATED APPLICATION

This application claims the benefit and priority of U.S. Provisional Patent Application No. 61/981,367 filed Apr. 18, 2014. The entire disclosures of the above application is incorporated herein by reference.

### FIELD

The present disclosure generally relates to Bluetooth communications and networks, including attribute repeating and aggregation.

### BACKGROUND

This section provides background information related to the present disclosure which is not necessarily prior art.

Bluetooth is a wireless technology standard that may be used to transfer data over short distances using short-wavelength ultrahigh frequency (UHF) radio waves in the ISM (Industrial Scientific and Medical) band from 2.4 Gigahertz (GHz) to 2.485 GHz. While Bluetooth is widely used and very versatile, Bluetooth enabled devices tend to have limited range. Where there is an intervening structure or equipment between two communicating Bluetooth devices, range can become further restricted. Bluetooth attributes may describe services and/or characteristics of a Bluetooth device. Bluetooth low energy (BLE) is a related technology for providing communications with reduced power consumption. In some Bluetooth communications, a Bluetooth master device is only able to communicate with up to ten Bluetooth slave devices.

### SUMMARY

This section provides a general summary of the disclosure, and is not a comprehensive disclosure of its full scope or all of its features.

According to various aspects, exemplary embodiments are disclosed of a Bluetooth attribute repeating and aggregating apparatus. In an exemplary embodiment, a Bluetooth attribute repeating and aggregating apparatus generally includes first and second communication modules. The first communication module is configured as a Bluetooth master for receiving attributes from one or more target Bluetooth slave devices. The second communication module is configured as a Bluetooth slave for processing the received attributes and transmitting corresponding attribute information to a control Bluetooth master device. The first communication module is coupled to the second communication module via a hardware interface. The first communication module is configured to transmit the received attributes to the second communication module via the hardware interface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of an example repeater apparatus according to some aspects of the present disclosure;

FIG. 2 is a block diagram of an example deployed system including multiple repeater apparatuses according to some aspects of the present disclosure;

FIG. 3 is an example repeated service instance according to some aspects of the present disclosure; and

FIG. 4 is an example master control and response service instance according to some aspects of the present disclosure.

### DETAILED DESCRIPTION

Example embodiments will now be described more fully with reference to the accompanying drawings.

Disclosed herein are exemplary embodiments of Bluetooth apparatuses that may repeat and/or aggregate Bluetooth attributes. The Bluetooth apparatuses may enable a normal Bluetooth range (e.g., 100 meters line-of-sight, twenty meters in buildings, etc.) to be extended for attribute data transfer. The Bluetooth apparatuses may use aggregation to allow a normal connection limit to be increased virtually. The apparatuses may allow Bluetooth low energy master devices to connect to more than a normal maximum (e.g., ten slave devices, etc.) for the transfer of attributes. The Bluetooth apparatuses may be useful for in-building asset tracking (e.g., asset tracking in hospitals, etc.).

According to one example embodiment of the present disclosure, a Bluetooth attribute repeating and aggregating apparatus generally includes first and second communication modules. The first communication module is configured as a Bluetooth master for receiving attributes from one or more target Bluetooth slave devices. The second communication module is configured as a Bluetooth slave for processing the received attributes and transmitting corresponding attribute information to a control Bluetooth master device. The first communication module is coupled to the second communication module via a hardware interface. The first communication module is configured to transmit the received attributes to the second communication module via the hardware interface.

The first and second communication modules may be any suitable modules (broadly, instances, which may include chipsets, devices, etc.) capable of transmitting (broadly, sending) and/or receiving Bluetooth communication signals. The Bluetooth communications may involve standard Bluetooth protocols, Bluetooth low energy (BLE), etc. Each Bluetooth connection between two modules may follow a master/slave topology.

The first communication module may be configured as a Bluetooth master (central) role, and may be configured to connect to one or more target Bluetooth slaves (peripherals) (e.g., other Bluetooth modules configured in a slave role, etc.). The first communication module may be capable of connecting to multiple slaves. While some Bluetooth configurations may limit a master to connecting with only ten target slaves, based on hardware, etc., other configurations may allow the master to connect with a greater number of target slaves. Each target slave may be limited to connecting with only one master at a time. The first control module may receive attributes from each target Bluetooth slave using any suitable Bluetooth connection protocol, and is preferably a Bluetooth low energy instance.

The second communication module may be configured as a Bluetooth slave (broadly, peripheral) role, and may be configured to connect to a control Bluetooth master (other than the first communication module). The second communication module may transmit attributes to the control Bluetooth master using any suitable Bluetooth connection protocol, and is preferably a Bluetooth low energy instance.

The received attributes may be any suitable Bluetooth attribute data, such as, for example, data transferred according to the Bluetooth Attribute Protocol (ATT), the Bluetooth Generic Attribute Profile (GATT), data formatted as services and/or characteristics of a Bluetooth device, etc. An attribute may be a block of data having some metadata associated with it. For example, the metadata may be used to tag the attribute data as belonging to an original source slave device. The metadata may include expedited custom characteristics, descriptors, etc. The first communication module may access and receive attributes of the target Bluetooth slaves using any suitable Bluetooth connection protocol, while the target Bluetooth slaves may provide and transmit the attributes to the first communication module using any suitable Bluetooth connection. Each slave may have one or more attributes, and the first communication module may receive all or less than all attributes for each target Bluetooth slave.

The first and second communication modules may be coupled back to back via a hardware interface, and may incorporate suitable firmware. For example, the first and second communication modules may be coupled via a universal asynchronous receiver/transmitter (UART), an inter-integrated circuit (I2C), a serial peripheral interface bus (SPI), etc. The interface between the first and second communication modules may allow the modules to send information from one module to the other. For example, the interface may allow the first communication module to provide received attributes to the second communication module. The interface may be a one-way interface or a two-way interface, and may allow the two modules to share information without the need for a Bluetooth connection between them. Because the two modules do not need to share a Bluetooth connection, they are free to connect to other Bluetooth modules. For example, the first communication module may connect to target Bluetooth slaves to receive attributes, pass them along to the second communication module via the hardware interface, and allow the second communication module to provide corresponding attribute information to a control Bluetooth master.

The second communication module may be configured to process the received attributes before transmitting corresponding attribute information to a control Bluetooth master. The attribute may be a block of data which has some metadata associated with it. The second control module may process each received attribute by morphing the attribute metadata by adding additional metadata to the attribute metadata. In this exemplary manner, the attribute metadata may be repeated along with the additional added metadata. For example, each received attribute may have a mirror attribute created in the second communication module which may use a characteristic descriptor identifying the originating Bluetooth instance for the attribute. In some exemplary embodiments, the characteristic descriptor may include the originating Bluetooth instance's media access control (MAC) address and/or a unique identifier if the MAC address is of a random type.

The second communication module may create each mirror attribute in the GATT table of the second communication module. Therefore, when a control Bluetooth master connects to the second communication module it can receive the corresponding attribute information. Because the second communication module may have corresponding attribute information for multiple target Bluetooth slaves, the added characteristic descriptors may allow the control Bluetooth master to still keep track of the attributes for the multiple target Bluetooth slaves, even though it is only accessing a single second communication module. The second communication module may also propagate a notify signal if the control Bluetooth master has enabled notification.

The first and second communication modules may each be configured to transmit and receive Bluetooth communication signals. For example, the second communication module may be configured to receive incoming control data from the control Bluetooth master device. The incoming control data may be transferred to the first communication module via the hardware interface, wherein the first communication module may be configured to transmit the received incoming control data to one or more of the target Bluetooth slaves to update one or more attributes in the target Bluetooth slave devices. According to this example, Bluetooth low energy attributes may also allow incoming data (e.g., write function as opposed to read function, etc.), and the first and second communication modules may be configured to allow the data to be relayed in the opposite direction so that target attributes in slaves can be updated.

The first communication module may be configured to receive attributes from multiple target Bluetooth slaves. For example, the first communication module may receive attributes from ten different target Bluetooth slaves. These attributes may then be transmitted to the second communication module via the hardware interface. The second communication module may be configured to transmit corresponding attribute information for each of the multiple received attributes to the control Bluetooth master. Corresponding attribute information for each of the received attributes may be transmitted via a single Bluetooth low energy connection to the control Bluetooth master device. For example, the second communication module may transmit corresponding attribute information for each of ten different target Bluetooth slaves in a single Bluetooth low energy connection to the control Bluetooth master.

The aggregation function of the Bluetooth apparatus may allow the Bluetooth apparatus to provide attributes from multiple target Bluetooth slaves to a control Bluetooth master via a single connection to the control Bluetooth master. This may increase the connection limit of the control Bluetooth master. The first Bluetooth apparatus may receive attributes from first and second target Bluetooth slaves and transmit corresponding attribute information to the control Bluetooth master over a first Bluetooth connection, while a second Bluetooth apparatus may receive attributes from third and fourth target Bluetooth slaves and transmit corresponding attribute information to the control Bluetooth master over a second connection. In this example, the control Bluetooth master may receive attributes from four different target Bluetooth slaves using only two Bluetooth connections.

This aggregation function can be extended virtually to further increase the connection limit of the control Bluetooth master. For example, there may be ten different Bluetooth apparatuses each receiving attributes from a different set of ten target Bluetooth slaves. Because the control Bluetooth master only needs a single Bluetooth connection to each Bluetooth apparatus, a single control Bluetooth master may be capable of receiving attributes from up to one hundred different target Bluetooth slaves. Although this example involves a limit of only ten Bluetooth slave connections for each Bluetooth master, it is understood that other aggregation limits may be used where Bluetooth master/slave connection limits are more or less than ten per device.

According to another example embodiment, a Bluetooth device may be capable of acting as both a master device and a slave device at substantially the same time (e.g., by communicating as a master device and a slave device simultaneously, by alternating between master device communications and slave device communications, etc.). The ability to act as both a master device and a slave device may be possible in Bluetooth devices having a specification which allows for this configuration. In this embodiment, the Bluetooth device is configured to act as a Bluetooth master for receiving attributes from one or more target Bluetooth slave devices. The Bluetooth device is also configured to act as a Bluetooth slave device for transmitting information corresponding to the received attributes to a control Bluetooth master device. The Bluetooth device is configured to process the attributes received when the device is acting as a Bluetooth master to generate corresponding information to be transmitted when the device is acting as a Bluetooth slave.

This example embodiment device may be configured to perform attribute repetition and/or aggregation in a similar manner to other Bluetooth repeating and aggregating apparatuses described herein, while using only a single Bluetooth device instead of connected first and second communication modules. For example, when the Bluetooth device of this example embodiment is operating in a Bluetooth master role, it may be configured in the same manner as a first communication module of other embodiments described herein (e.g., configured to receive attribute information from one or more target slaves). When the Bluetooth device of this example embodiment is operating in a slave role, it may be configured in the same manner as a second communication module of other embodiments described herein (e.g., configured to transmit information corresponding to the received attributes to a control Bluetooth master device). However, instead of first and second communication modules sharing information between each other via a hardware interface, the single Bluetooth device of this embodiment may process and transmit information between its master and slave roles internally. As should be apparent, the teachings disclosed herein regarding the first and second communication module embodiments may also be applicable to this single Bluetooth device embodiment (e.g., aggregating attributes to increase a connection limit, sending and receiving signals between control Bluetooth master devices and target Bluetooth slave devices, etc.).

In this single Bluetooth device embodiment, each received attribute may include a block of data having a first metadata. The Bluetooth device may be configured to process the received attribute by adding a second metadata to the first metadata. Alternatively, or in addition, the Bluetooth device may be configured to process each received attribute by creating a mirror attribute corresponding to the attribute. The mirror attribute includes at least one characteristic descriptor identifying an originating Bluetooth device for the mirror attribute. As yet another alternative, or in addition, the Bluetooth device may be configured to process each received attribute by creating a mirror attribute corresponding to the received attribute in a generic attribute profile (GATT) table of the Bluetooth device. The Bluetooth device may be configured to propagate a notify signal to the control Bluetooth master device if the control Bluetooth master is configured to receive notification.

The Bluetooth device may be configured to receive attributes from multiple target Bluetooth slave devices. The Bluetooth may also be configured to transmit corresponding attribute information for each of the received attributes via a single Bluetooth low energy (BLE) connection to the control Bluetooth master device.

According to another example embodiment, a method of repeating and aggregating Bluetooth attributes includes receiving an attribute from at least one target Bluetooth slave module, processing the received attribute to create corresponding attribute information including the attribute data and originating Bluetooth device information for the received attribute, and transmitting the processed attribute information to a control Bluetooth master device.

As should be apparent, the example method may be performed by any Bluetooth apparatus described herein. For example, the attribute may be received at a first communication module, the received attribute may be transmitted to a second communication module via a hardware interface coupling the first and second communication modules, and the corresponding attribute information may be transmitted by the second communication module.

According to another example embodiment, an apparatus master instance may be configured to make connections to multiple dedicated slaves via bonding or otherwise, and may be further configured to extract data from specific attributes from those slaves. The extracted data information may then be passed to an apparatus slave instance connected to the apparatus master instance via a hardware interface. The apparatus slave instance may create the attributes in its own GATT table so that when a wireless connection is made to the apparatus slave instance it can provide the data. This may effectively extend the range over which specific attribute data is available from nominated slaves.

According to another example embodiment, a system for propagating Bluetooth network information includes a communication network having multiple Bluetooth devices. Each Bluetooth device is in communication with at least one of the other multiple Bluetooth devices via a direct Bluetooth wireless connection, such that each Bluetooth device is connected to all of the multiple Bluetooth devices via a direct Bluetooth connection and/or via an indirect Bluetooth connection including one or more of the other multiple Bluetooth devices. Each Bluetooth device is configured to detect node status information from each other Bluetooth device directly connected to the Bluetooth device, and is configured to transmit the detected node status information to the other Bluetooth devices directly connected to the Bluetooth device, such that each Bluetooth device in the communication network includes node status information for all Bluetooth devices in the network. Alternatively, or in addition, node status information can be propagated using advertising beacons, such that a Bluetooth connection is not required. The advertising node status information can optionally be encrypted (e.g., using an advanced encryption standard (AES) algorithm, etc.) to enable a secure channel for information transfer via advertisement.

Bluetooth devices in the communication network may communicate via a Bluetooth low energy (BLE) communication protocol (e.g., Bluetooth 4.0, 4.1, etc.), which may provide ultra-low power network communication. The communication network may be a low power distributed system node status (status of a Bluetooth device) and/or existence propagates throughout the network such that each node (Bluetooth device) contains a complete copy of the network as a whole.

Node status information may include any information related to the status of a Bluetooth device (e.g., an existence of the Bluetooth device, a service of the Bluetooth device, a universally unique identifier (UUID) of the Bluetooth device, a characteristic value of the Bluetooth device, a received signal strength indication (RSSI) value for calculation of an overall path ‘quality of service’, etc.). A Bluetooth device may be configured to detect new node status information and append the detected new node status information to its generic attribute profile (GATT) table and/or its service list. Bluetooth devices may be configured in master and/or client roles with multi-link simultaneously.

The communication network may be included in systems that could benefit from being able to access node status for all nodes in the network via a single communication point. For example, a heating, ventilating and air-conditioning (HVAC) system may include a communication network as described herein. Bluetooth devices in the communication network may be configured to detect temperatures and/or pressures in different rooms and/or ventilation portions of the HVAC system. This may allow for monitoring of the temperatures and/or pressures in each of the rooms and/or ventilation portions from a connection to a single point (Bluetooth device) in the network.

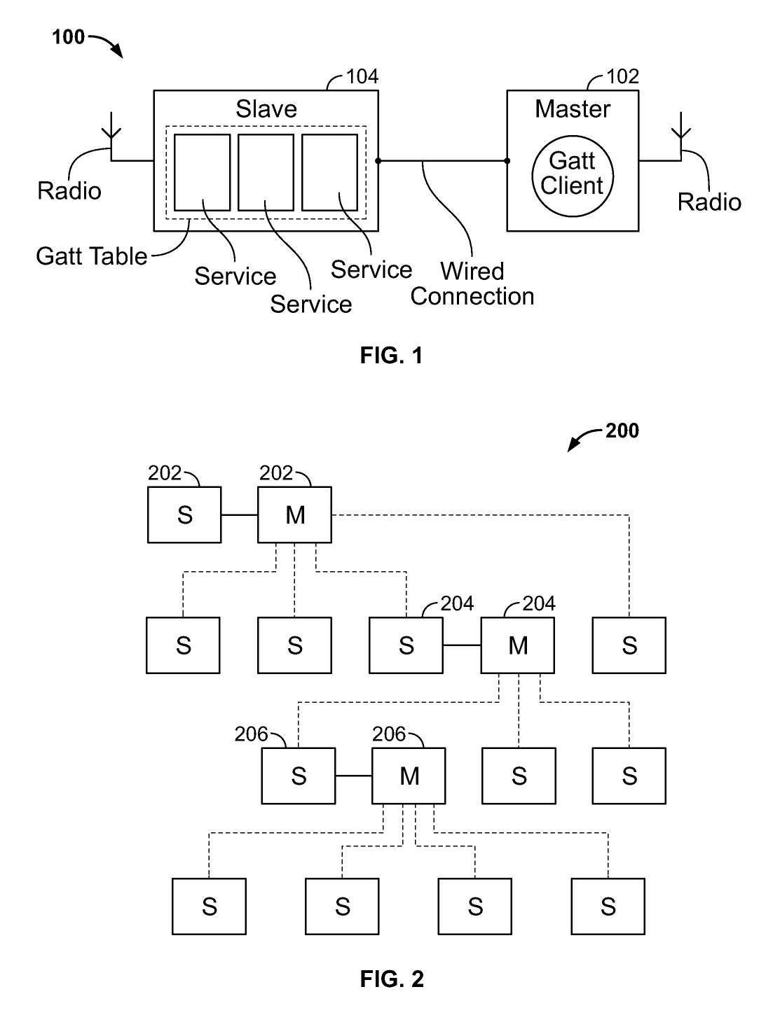

Referring now to the figures, FIG. 1 illustrates an example repeater apparatus 100 (alternatively, node or station) having a ‘MASTER’ first communication module 102 configured to collect information from target slave devices via a radio (e.g., Bluetooth) wireless connection. The repeater apparatus also includes a ‘SLAVE’ second communication module 104 configured to send information to/from a remote master control device via a radio wireless connection. The first communication module 102 is coupled to the second communication module 104 via a wired connection. The first communication module 102 includes a GATT client and the second communication module 104 includes a GATT table having multiple services. At least one of the services is a ‘repeater master’ controller service which is used to trigger the first communication module 102 to scan for target slave devices. The first communication module 102 is configured to collect information from target slave devices and update services in the second communication module 104. The second communication module 104 is configured to receive write signals from a remote master control device and relay the write signals to the GATT client of the first communication module 102 for transmission to target slave devices.

Although the example repeater apparatus 100 illustrated in FIG. 1 includes two Bluetooth devices, it should be apparent that other embodiments may include a repeater apparatus having only a single Bluetooth device capable of performing the roles of both the ‘MASTER’ first communication module 102, and the ‘SLAVE’ second communication module 104.

FIG. 2 illustrates a typical deployed system 200 according to some aspects of the present disclosure. As shown, a first repeater apparatus 202 includes a slave device (S) coupled to a master device (M) via a wired connection. The master device (M) of repeater 202 is wirelessly connected to multiple target slaves, including a slave device (S) of repeater apparatus 204. The slave device (S) of repeater apparatus 204 is coupled to a master device (M) of repeater 204 via a wired connection. The master device (M) of repeater 204 is wirelessly connected to multiple target slaves, including a slave device (S) of repeater apparatus 206. Repeater 206 also includes a master device (M) connected to the slave device (S) via a wired connection. The master device (M) of repeater 206 is wirelessly connected to multiple target slave devices. In this example system 200, repeater 202 is able to receive attribute information from all target slave devices in the system 200. Some attribute information is provided through a single direct wireless connection to the master device (M) of repeater 202, while some attribute information must be passed along via multiple repeaters (e.g., from repeater 206 to repeater 204, then from repeater 204 to repeater 202, etc.). Although one example deployment is illustrated in FIG. 2, it is understood that any other suitable configuration may be used, including more or less repeater levels, without departing from the scope of the present disclosure.

Although the example repeater apparatuses 202-206 illustrated in FIG. 2 each includes two Bluetooth devices, it should be apparent that other embodiments may include a repeater apparatus having only a single Bluetooth device capable of performing both the master and slave roles at substantially the same time.

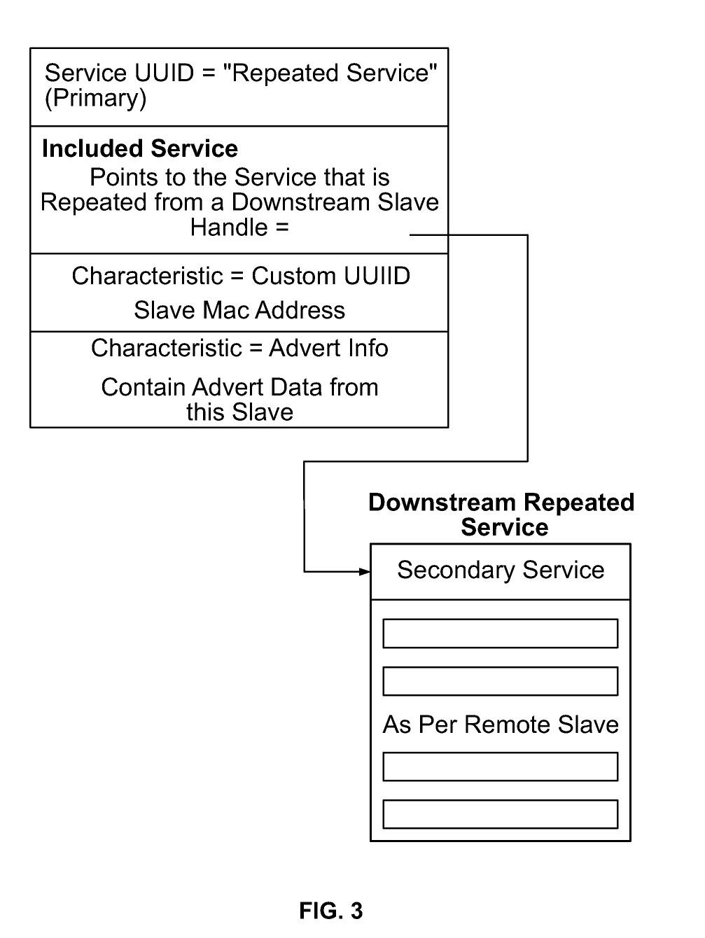

FIG. 3 illustrates an example repeated service instance, which may be included in the GATT table of the ‘SLAVE’ second communication module 104 of FIG. 1. The repeated service instance includes a UUID=“Repeated Service” (Primary). The included service points to a service that is repeated from a downstream target slave device. For example, the handle may include a secondary service from a downstream repeated service of a remote target slave device. The repeated service instance also includes a characteristic for a custom UUID, and a slave device MAC address. The repeated service instance further includes a characteristic for advertising information for the second communication module 104.

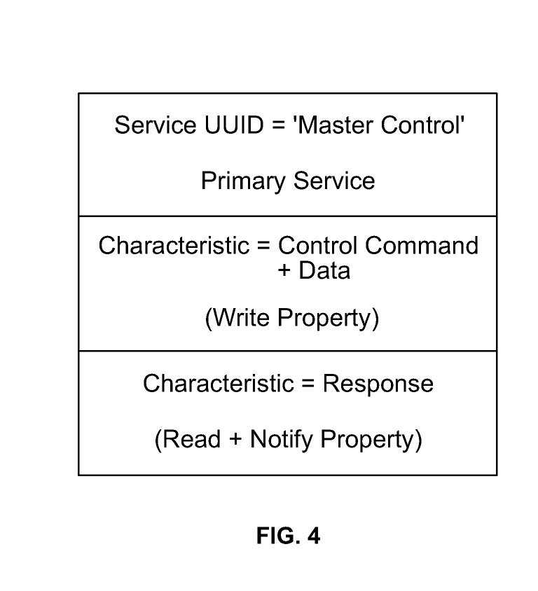

FIG. 4 illustrates an example service instance for master control and response, which may be included in the GATT table of the ‘SLAVE’ second communication module 104 of FIG. 1. The master control and response service instance includes a service UUID=‘Master Control’ (Primary). The master control and response service instance also includes a characteristic for a control command and data, which includes a write property. The master control and response service instance further includes a characteristic for response, which includes a read and notify property. This master control and response service may be used to relay commands from a remote master control device to the first communication module 102. The service may also be used to relay back any response from the first communication module 102 to the remote master control device via notifications.

Exemplary embodiments of Bluetooth apparatuses and systems are disclosed herein that may provide one or more of the following advantages. Exemplary Bluetooth apparatuses may extend the range over which attribute information may be communicated. Some Bluetooth apparatuses may allow for a virtual increase in the connection limit, such that a single control Bluetooth master instance can receive attribute data from an increased number of target Bluetooth slave instances. This repeater/aggregation topology may allow systems (e.g., asset tracking in hospitals, etc.) to be expedited so that attribute data hopping can be used to effectively get attribute information over a much wider area. Further, exemplary Bluetooth communication network systems may uses less power, and may not require immediate direct communication or routing. Full system information may be accessible from any node at any location in the communication network.

In an exemplary embodiment, a Bluetooth attribute repeating and aggregating apparatus generally includes first and second communication modules. The first communication module is configured as a Bluetooth master for receiving attributes from one or more target Bluetooth slave devices. The second communication module is configured as a Bluetooth slave for processing the received attributes and transmitting corresponding attribute information to a control Bluetooth master device. The first communication module is coupled to the second communication module via a hardware interface. The first communication module is configured to transmit the received attributes to the second communication module via the hardware interface.

Each received attribute may include a block of data having a first metadata. The second communication module may be configured to process the received attribute by adding a second metadata to the first metadata.

The second communication module may be configured to process each received attribute by creating a mirror attribute corresponding to the attribute. The mirror attribute may include at least one characteristic descriptor identifying an originating Bluetooth device for the mirror attribute. The characteristic descriptor may include a media access control (MAC) address of the originating Bluetooth device.

The second communication module may be configured to process each received attribute by creating a mirror attribute corresponding to the received attribute in a generic attribute profile (GATT) table of the second communication module and/or propagate a notify signal to the control Bluetooth master device.

The first communication module may be configured to receive and transmit Bluetooth communication signals. The second communication module may be configured to receive and transmit Bluetooth communication signals. The second communication module may be configured to receive incoming control data from the control Bluetooth master device. The first communication module may be configured to transmit the received incoming control data to one or more of the target Bluetooth slave devices to update one or more attributes in the target Bluetooth slave devices.

The hardware interface may include at least one of a universal asynchronous receiver/transmitter (UART), an inter-integrated circuit (I2C), and a serial peripheral interface (SPI).

The first communication module may be configured to receive attributes from multiple target Bluetooth slave devices. The second communication module may be configured to transmit corresponding attribute information for each of the received attributes via a single Bluetooth low energy (BLE) connection to the control Bluetooth master device.

An exemplary embodiment of a Bluetooth attribute repeating and aggregating system may include first and second Bluetooth attribute repeating and aggregating apparatus. The first apparatus may be configured to receive attributes from first and second target Bluetooth slave devices and transmit corresponding attribute information to a control Bluetooth master device via a first Bluetooth connection. The second apparatus may be configured to receive attributes from third and fourth target Bluetooth slave devices and transmit corresponding attribute information to the control Bluetooth master device via a second Bluetooth connection.

An exemplary embodiment of a method of repeating and aggregating Bluetooth attributes generally includes receiving an attribute from at least one target Bluetooth slave device; processing the received attribute to create corresponding attribute information including the received attribute and originating Bluetooth device information for the received attribute; and transmitting the processed attribute information to a control Bluetooth master device.

In this exemplary method, receiving may include receiving an attribute at a first communication module; and transmitting may include transmitting processed attribute information at a second communication module. The method may further comprise transmitting the received attribute from the first communication module to the second communication module via a hardware interface coupled between the first communication module and the second communication module. Also in this exemplary method, processing the received attribute may include creating a mirror attribute corresponding to the received attribute in a generic attribute profile (GATT) table of the second communication module.

Each received attribute may include a block of data having a first metadata. And, processing the received attribute may include adding a second metadata to the first metadata.

Processing the received attribute may include creating a mirror attribute corresponding to the attribute. The mirror attribute may include at least one characteristic descriptor identifying an originating Bluetooth device for the mirror attribute. The characteristic descriptor may include a media access control (MAC) address of the originating Bluetooth device and/or a unique identifier if the MAC address has a random type.

The method may further comprise receiving incoming control data from the control Bluetooth master device, and transmitting the received incoming control data to the target Bluetooth slave device to update an attribute in the target Bluetooth slave device.

Receiving may include receiving attributes from multiple target Bluetooth slave devices. Transmitting may include transmitting corresponding attribute information for each of the received attributes via a single Bluetooth low energy (BLE) connection to the control Bluetooth master device.

Receiving may include includes receiving attributes from first and second target Bluetooth slave devices. Transmitting may include transmitting corresponding attribute information to the control Bluetooth master device via a first Bluetooth connection. Receiving may further comprise receiving attributes from third and fourth target Bluetooth slave devices. Transmitting may further comprise transmitting corresponding attribute information to the control Bluetooth master device via a second Bluetooth connection.

An exemplary embodiment of a system for propagating Bluetooth network information generally includes a communication network including multiple Bluetooth devices. Each Bluetooth device is in communication with at least one of the other multiple Bluetooth devices via a direct Bluetooth wireless connection, such that each Bluetooth device is connected to all of the multiple Bluetooth devices via a direct Bluetooth connection and/or via an indirect Bluetooth connection including one or more of the other multiple Bluetooth devices. Each Bluetooth device is configured to detect node status information from each other Bluetooth device directly connected to the Bluetooth device and transmit the detected node status information to the other Bluetooth devices directly connected to the Bluetooth device, such that each Bluetooth device in the communication network includes node status information for all Bluetooth devices in the network.

Node status information for a Bluetooth device may include at least one of an existence of the Bluetooth device, a service of the Bluetooth device, a universally unique identifier (UUID) of the Bluetooth device, and a characteristic value of the Bluetooth device.

Each Bluetooth device may be configured to detect and transmit node status information by detecting new node status information and appending the detected new node status information to a generic attribute profile (GATT) of the Bluetooth device and/or a service list of the Bluetooth device.

Each Bluetooth device may be configured to communicate using a Bluetooth low energy (BLE) communication protocol. Each Bluetooth device is configured to communicate using a Bluetooth 4.0 and/or 4.1 communication protocol.

In an exemplary embodiment, a heating, ventilation and air-conditioning (HVAC) system may include a system for propagating Bluetooth network information having a communication network as described herein. The communication network may be configured to allow monitoring of temperatures and/or pressures in each room and/or ventilation portion of the HVAC system from a Bluetooth connection to a single Bluetooth device in the communication network.

In another exemplary embodiment, a Bluetooth attribute repeating and aggregating apparatus includes a Bluetooth device configured to act as a Bluetooth master for receiving attributes from one or more target Bluetooth slave devices. The Bluetooth device is also configured to act as a Bluetooth slave for transmitting attribute information corresponding to the received attributes to a control Bluetooth master device. The Bluetooth device is further configured to process the attributes received when the device is acting as a Bluetooth master to generate the corresponding attribute information to be transmitted when the device is acting as a Bluetooth slave.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A Bluetooth attribute repeating and aggregating apparatus comprising:
a first communication module configured as a Bluetooth master for receiving attributes from one or more target Bluetooth slave devices; and
a second communication module configured as a Bluetooth slave for processing the received attributes and transmitting corresponding attribute information to a control Bluetooth master device;
wherein:
the first communication module is coupled to the second communication module via a hardware interface; and
the first communication module is configured to transmit the received attributes to the second communication module via the hardware interface.

2. The apparatus of claim 1, wherein:
each received attribute includes a block of data having a first metadata; and
the second communication module is configured to process the received attribute by adding a second metadata to the first metadata.

3. The apparatus of claim 1, wherein:
the second communication module is configured to process each received attribute by creating a mirror attribute corresponding to the received attribute, the mirror attribute including at least one characteristic descriptor identifying an originating Bluetooth device for the mirror attribute; and/or
the second communication module is configured to process each received attribute by creating a mirror attribute corresponding to the received attribute in a generic attribute profile (GATT) table of the second communication module and/or propagate a notify signal to the control Bluetooth master device.

4. The apparatus of claim 1, wherein the second communication module is configured to process each received attribute by creating a mirror attribute corresponding to the received attribute, the mirror attribute including at least one characteristic descriptor identifying an originating Bluetooth device for the mirror attribute, the characteristic descriptor including a media access control (MAC) address of the originating Bluetooth device.

5. The apparatus of claim 1, wherein:
the first communication module is configured to receive and transmit Bluetooth communication signals; and
the second communication module is configured to receive and transmit Bluetooth communication signals.

6. The apparatus of claim 5, wherein:
the second communication module is configured to receive incoming control data from the control Bluetooth master device; and
the first communication module is configured to transmit the received incoming control data to one or more of the target Bluetooth slave devices to update one or more attributes in the target Bluetooth slave devices.

7. The apparatus of claim 1, wherein the hardware interface includes at least one of a universal asynchronous receiver/transmitter (UART), an inter-integrated circuit (I2C), and a serial peripheral interface (SPI).

8. The apparatus of claim 1, wherein:
the first communication module is configured to receive attributes from multiple target Bluetooth slave devices; and
the second communication module is configured to transmit corresponding attribute information for each of the received attributes via a single Bluetooth low energy (BLE) connection to the control Bluetooth master device.

9. A Bluetooth attribute repeating and aggregating system including a first apparatus according to claim 1 and a second apparatus according to claim 1, wherein:
the first apparatus is configured to receive attributes from first and second target Bluetooth slave devices and transmit corresponding attribute information to a control Bluetooth master device via a first Bluetooth connection; and
the second apparatus is configured to receive attributes from third and fourth target Bluetooth slave devices and transmit corresponding attribute information to the control Bluetooth master device via a second Bluetooth connection.

10. A method of repeating and aggregating Bluetooth attributes, the method comprising:
receiving an attribute from at least one target Bluetooth slave device;
processing the received attribute to create corresponding attribute information including the received attribute and originating Bluetooth device information for the received attribute; and
transmitting the processed attribute information to a control Bluetooth master device.

11. The method of claim 10, wherein:
receiving includes receiving an attribute at a first communication module;
transmitting includes transmitting processed attribute information at a second communication module; and
the method further comprises transmitting the received attribute from the first communication module to the second communication module via a hardware interface coupled between the first communication module and the second communication module.

12. The method of claim 10, wherein:
processing the received attribute includes creating a mirror attribute corresponding to the received attribute in a generic attribute profile (GATT) table of the second communication module; and/or
each received attribute includes a block of data having a first metadata, and processing the received attribute includes adding a second metadata to the first metadata; and/or
processing the received attribute includes creating a mirror attribute corresponding to the received attribute, the mirror attribute including at least one characteristic descriptor identifying an originating Bluetooth device for the mirror attribute.

13. The method of claim 10, wherein processing the received attribute includes creating a mirror attribute corresponding to the attribute, the mirror attribute including at least one characteristic descriptor identifying an originating Bluetooth device for the mirror attribute, the characteristic descriptor including a media access control (MAC) address of the originating Bluetooth device and/or a unique identifier if the MAC address has a random type.

14. The method of claim 10, further comprising receiving incoming control data from the control Bluetooth master device, and transmitting the received incoming control data to the target Bluetooth slave device to update an attribute in the target Bluetooth slave device.

15. The method of claim 10, wherein:
receiving includes receiving attributes from multiple target Bluetooth slave devices; and
transmitting includes transmitting corresponding attribute information for each of the received attributes via a single Bluetooth low energy (BLE) connection to the control Bluetooth master device.

16. The method of claim 10, wherein:
receiving includes receiving attributes from first and second target Bluetooth slave devices;
transmitting includes transmitting corresponding attribute information to the control Bluetooth master device via a first Bluetooth connection;
receiving further comprises receiving attributes from third and fourth target Bluetooth slave devices; and
transmitting further comprises transmitting corresponding attribute information to the control Bluetooth master device via a second Bluetooth connection.

17. A system for propagating Bluetooth network information, the system comprising:
a communication network including multiple Bluetooth devices, each Bluetooth device in communication with at least one of the other multiple Bluetooth devices via a direct Bluetooth wireless connection, such that each Bluetooth device is connected to all of the multiple Bluetooth devices via a direct Bluetooth connection and/or via an indirect Bluetooth connection including one or more of the other multiple Bluetooth devices;
each Bluetooth device configured to detect node status information from each other Bluetooth device directly connected to the Bluetooth device and transmit the detected node status information to the other Bluetooth devices directly connected to the Bluetooth device, such that each Bluetooth device in the communication network includes node status information for all Bluetooth devices in the network.

18. The system of claim 17, wherein node status information for a Bluetooth device includes at least one of an existence of the Bluetooth device, a service of the Bluetooth device, a universally unique identifier (UUID) of the Bluetooth device, and a characteristic value of the Bluetooth device.

19. The system of claim 17, wherein each Bluetooth device is configured to detect and transmit node status information by detecting new node status information and appending the detected new node status information to a generic attribute profile (GATT) of the Bluetooth device and/or a service list of the Bluetooth device.

20. The system of claim 17, wherein:
each Bluetooth device is configured to communicate using a Bluetooth low energy (BLE) communication protocol; and/or
each Bluetooth device is configured to communicate using a Bluetooth 4.0 and/or 4.1 communication protocol.

21. A heating, ventilation and air-conditioning (HVAC) system including the system of claim 17, wherein the communication network is configured to allow monitoring of temperatures and/or pressures in each room and/or ventilation portion of the HVAC system from a Bluetooth connection to a single Bluetooth device in the communication network.

22. A Bluetooth attribute repeating and aggregating apparatus comprising:
a Bluetooth device configured to act as a Bluetooth master for receiving attributes from one or more target Bluetooth slave devices;
wherein the Bluetooth device is also configured to act as a Bluetooth slave for transmitting attribute information corresponding to the received attributes to a control Bluetooth master device, and
the Bluetooth device is configured to process the attributes received when the device is acting as a Bluetooth master to generate the corresponding attribute information to be transmitted when the device is acting as a Bluetooth slave.

23. The apparatus of claim 22, wherein:
each received attribute includes a block of data having a first metadata; and
the Bluetooth device is configured to process the received attribute by adding a second metadata to the first metadata.

24. The apparatus of claim 22, wherein:
the Bluetooth device is configured to process each received attribute by creating a mirror attribute corresponding to the received attribute, the mirror attribute including at least one characteristic descriptor identifying an originating Bluetooth device for the mirror attribute; and/or
the Bluetooth device is configured to process each received attribute by creating a mirror attribute corresponding to the received attribute in a generic attribute profile (GATT) table of the Bluetooth device and/or propagate a notify signal to the control Bluetooth master device.

25. The apparatus of claim 22, wherein:
the Bluetooth device is configured to receive attributes from multiple target Bluetooth slave devices; and
the Bluetooth device is configured to transmit corresponding attribute information for each of the received attributes via a single Bluetooth low energy (BLE) connection to the control Bluetooth master device.
